(19) United States
(12) Patent Application Publication
(10) Pub. No.: US 2024/0319893 A1
(43) Pub. Date: Sep. 26, 2024

(54) STORAGE CAPACITY MANAGEMENT TO MITIGATE OUT-OF-SPACE CONDITIONS IN A STORAGE SYSTEM

(71) Applicant: INTERNATIONAL BUSINESS MACHINES CORPORATION, Armonk, NY (US)

(72) Inventors: Terry Wade NIEMEYER, Austin, TX (US); Mark Allen SISTRUNK, Austin, TX (US); Lori Christine SIMCOX, Los Gatos, CA (US); Andrew Paul GELLAI, SR., Tucson, AZ (US); Navin MANOHAR, Cedar Park, TX (US)

(21) Appl. No.: 18/186,644

(22) Filed: Mar. 20, 2023

(51) Int. Cl. G06F 3/06

(52) U.S. Cl. CPC G06F 3/0631; G06F 3/0604; G06F 3/0644; G06F 3/0689

(57) ABSTRACT

A computer program product, system, and method are provided for out-of-space condition risk mitigation. In one embodiment, a donor pool contained within a storage pool, provides additional storage capacity which may be transferred to another storage pool which may be approaching an out-of-space condition. Donated storage capacity may be virtual and may be transferred on a temporary or emergency basis to prevent an imminent out-of-space condition. Donated storage capacity may be returned to the donor pool once the donated storage capacity is no longer needed by the recipient storage pool.

### BACKGROUND OF THE INVENTION

### 1. Field of the Invention

The present invention relates to a computer program product, system, and method for mitigating risk of out-of-space conditions in a storage system.

### 2. Description of the Related Art

Storage capacity of enterprise storage systems is often partitioned into storage pools in order to assign a specific amount of storage capacity to a given application or department. Storage pools can also create failure domains to isolate failure of storage in one pool from affecting storage in another pool. Each storage pool is typically assigned a predetermined amount of storage capacity provided by internal physical storage such as a Redundant Array of Independent Drives (or RAID array) within the storage system or by virtual storage which is mapped to physical storage which may be internal or external to the system.

A storage system typically includes one or more storage controllers which control the storage drives which provide the actual storage capacity. User applications typically run on one or more hosts which communicate with the storage controllers through one or more storage area networks (SANs) in enterprise storage systems.

In one known storage system, storage pools are created as logical containers that group together various managed disks (often referred to as “mdisks”) each of which is a building block of usable storage capacity. The actual storage capacity of an mdisk is provided by block storage that may be virtualized from internal or external physical storage or provided directly by physical storage such as a RAID array, for example.

In addition, a logical unit number, or LUN, is a number used to identify a logical unit, which is a device addressed in accordance with a protocol such as the Small System Computer Interface (SCSI) standard, or by Storage Area Network (SAN) protocols that encapsulate SCSI, such as Fibre Channel or iSCSI, for example. The use of LUNs can simplify the management of storage resources because logical identifiers can be used to assign access and control privileges governing access to storage resources. One or more LUNs may be grouped together as a volume which is typically assigned to a host to provide access to storage capacity for use by the host and applications running on the host. A volume assigned to a host may be virtualized and used as an mdisk by another storage system.

If the storage in a pool is not managed properly, an out-of-space condition can occur as data written in input/output (I/O) operations consumes all the storage capacity of a storage pool, resulting in application down time or failure. This can result in emergency situations for storage administrators and for application owners that depend on those storage pools. Such a situation can happen at the most inconvenient times such as high utilization periods for applications.

Various techniques have been proposed to reduce or eliminate the occurrence of such out-of-space conditions. For example, it is known to configure a storage system to monitor consumption of usable storage system capacity and report to a system administrator the remaining usable storage capacity. Thus, known storage systems have warning thresholds for storage pools where a warning is triggered as the capacity that is consumed in the storage pool exceeds that threshold. However, if such reporting has not been enabled, the administrator may be unaware of an existing or imminent out-of-space condition.

Other configurations of the storage system may inadvertently interfere with accurate monitoring of remaining usable storage system capacity. For example, use of data compression in a storage system may interfere with accurate monitoring, resulting in an out-of-space condition. Until it is discovered that a particular configuration interferes with accurate monitoring, and such interference is corrected, out-of-space conditions may be encountered.

Thus, in many known storage systems, a storage administrator may be required to see a warning that a particular storage pool is about to run out of available storage capacity, and to take some manual action such as moving volumes to the storage pool, adding additional arrays to the storage pool or expanding existing arrays in the storage pool. While these methods may be effective in mitigating an out-of-space condition if carried out in a timely manner, they are typically manual and can be ineffective if not carried out before all capacity is consumed. Additionally, such methods may result in a performance impact to the storage system as extents of written data are transferred from the problematic storage pool to another pool or extents in the problematic storage pool are rebalanced amongst the physical or virtual storage devices of the pool.

Another technique proposed to reduce or eliminate the occurrence of such out-of-space conditions is to automatically convert volumes which may be running low on available storage capacity, to read-only status to prevent the writing of additional data to such volumes until the storage capacity problem may be addressed by the system administrator. Yet another approach proposed is to unmount a drive automatically if physical storage space is exhausted. However, such volume conversions to read-only status or unmounting of drives may significantly interfere with on-going input/output (I/O) operations for a host relying upon write access to those volumes or drives.

Still another approach is to reserve a portion of the storage capacity of a storage pool for emergency use only. Such an approach can significantly reduce the amount of storage capacity available for normal, non-emergency I/O operations.

### SUMMARY

Providing a computer program product, system, and method for mitigating risk of out-of-space conditions in a storage system by providing in one embodiment, a first storage pool which includes a donor storage pool having donor storage capacity. In one aspect of out-of-space condition risk mitigation management in accordance with the present description, capacity usage of a second storage pool is monitored and a potential out-of-space condition in the second storage pool may be detected as a function of the capacity usage monitoring of the second storage pool. In response to detection of a potential out-of-space condition in the second storage pool, donor storage capacity from the donor pool of the first storage pool is donated to the second storage pool so that donated storage capacity is transferred to the second storage pool. In one embodiment, the transfer of donor storage capacity may be done on a temporary basis and the donated storage capacity may be returned to the donor storage pool when no longer needed by the second storage pool. Other aspects and advantages may be provided, depending upon the particular application.

### BRIEF DESCRIPTION OF THE DRAWINGS

FIG. 1A illustrates an embodiment of a computing environment employing an aspect of out-of-space condition risk mitigation management in accordance with the present description.

FIG. 1B illustrates a high-level block-diagram representation of an enterprise computer system in which out-of-space condition risk mitigation management in accordance with the present description is employed;

FIG. 2 illustrates an exemplary block diagram of a hardware and software structure of a data storage system in a computer system in which out-of-space condition risk mitigation management in accordance with the present description is employed;

FIG. 3 illustrates a prior art configuration of a storage pool;

FIG. 4 illustrates a prior art mapping of a volume to an mdisk and a prior art mapping of an mdisk to a block of physical storage;

FIG. 5 illustrates an embodiment of operations for out-of-space condition risk mitigation management in accordance with the present description;

FIG. 6 illustrates a storage pool configured to include a donor pool for out-of-space condition risk mitigation management in accordance with the present description;

FIG. 7 illustrates an embodiment of configuration of donor pool and non-donor pool storage capacities of a storage pool configured for out-of-space condition risk mitigation management in accordance with the present description;

FIG. 8 depicts a more detailed embodiment of an out-of-space condition risk mitigation controller of the data storage system of FIG. 2;

FIG. 9 illustrates a more detailed embodiment of detection phase operations of the out-of-space condition risk mitigation operations of FIG. 5, in accordance with the present description;

FIG. 10 illustrates an example of usage of a storage pool having donor pool and non-donor pool storage capacities in accordance with one embodiment of the present description;

FIG. 11 illustrates a more detailed embodiment of action phase operations of the out-of-space condition risk mitigation operations of FIG. 5, in accordance with the present description;

FIG. 12A illustrates an embodiment of configuration of the storage capacity of the donor pool of the storage pool of FIG. 7, in which a donor volume has been allocated within the storage capacity of the donor pool for donation to another storage pool;

FIG. 12B illustrates an embodiment in which the storage capacity of the donor pool of FIG. 12A has been reduced by the transfer of a donor volume mapped to an mdisk to a recipient storage pool;

FIG. 12C illustrates an embodiment in which the storage capacity of the donor pool of FIG. 12A has been restored by the return of donor mdisks no longer needed by the recipient storage pool and the deletion of the donor volume from the donor pool; pool;

FIG. 13 illustrates a mapping of a donor volume to a donor mdisk and mapping of the donor mdisk to a block of physical storage;

FIG. 14 illustrates an embodiment of the storage pool of FIG. 10 having added donated storage capacity provided by a donor pool from another storage pool, in accordance with one embodiment of the present description;

FIG. 15 illustrates an embodiment of the storage pool of FIG. 10 having added new storage capacity in addition to donated storage capacity provided by a donor pool from another storage pool, in accordance with one embodiment of the present description;

FIG. 16 illustrates an embodiment of the storage pool of FIG. 10 having added storage capacity and having removed previously donated storage capacity provided by a donor pool from another storage pool, in accordance with one embodiment of the present description; and

FIG. 17 illustrates a computing environment in which the components of FIGS. 1A, 1B and 2 may be implemented.

### DETAILED DESCRIPTION

Described embodiments provide improved computer technology to mitigate risk of an out-of-space condition in a storage system. In one embodiment, a donor pool contained within a storage pool, provides additional storage capacity which may be transferred in an action phase to another storage pool which may be approaching an out-of-space condition. Donated storage capacity may be transferred on a temporary or emergency basis to prevent an imminent out-of-space condition and then returned to the donor pool once the emergency has passed and the donated storage capacity is no longer needed by the recipient storage pool.

In one aspect of out-of-space condition risk mitigation management in accordance with the present description, capacity usage of a storage pool may be monitored by the storage system in a detection phase so that potential out-of-space conditions in that storage pool may be detected as a function of the capacity usage monitoring of the pool. For example, measured capacity usage of a storage pool may be compared to a donation recipient threshold. If the measured capacity usage of the storage pool exceeds this donation recipient threshold, a potential out-of-space condition may be considered to be imminent. In this manner, exceeding the donation recipient threshold may be interpreted by the system as a warning of a dangerous level of capacity usage which may result in an out-of-space condition.

In response to detection of a potential out-of-space condition, units of virtual storage capacity such as managed disks (mdisks) having virtual donor volumes mapped to the mdisks, for example, may be donated in an action phase, from one or more donor pools contained within storage pools of the storage system to a recipient storage pool in which a potential out-of-space condition has been detected. Because the donor storage capacity may be virtual in one embodiment, the virtual donor storage capacity may be more easily or rapidly transferred to the recipient storage pool as compared to transfer of physical storage. In addition, because the virtual donor storage and the physical storage mapped to the virtual donor storage are preexisting prior to detection of a potential out-of-space condition, the donor virtual storage is readily available for transfer to a recipient storage pool.

In this manner, donor storage capacity may be rapidly added to a recipient storage pool in which an imminent out-of-space condition has been detected. As a result, the out-of-space condition may be prevented and normal I/O operations directed to the recipient storage pool may continue without disruption. For example, disruptive measures such as throttling down data write I/O operations or converting storage pools to read-only mode, may be avoided by the transfer of donor storage capacity to a recipient storage pool in danger of reaching an out-of-space condition.

In one embodiment, detection of potential out-of-space conditions and transfer of donor storage capacity in response to such detections, can be performed automatically by a storage system employing out-of-space condition risk mitigation in accordance with the present description. As a result, avoidance of out-of-space conditions need not rely wholly upon vigilance by a human system administrator to detect and address imminent out-of-space conditions before an out-of-space condition can cause substantial disruptions to I/O operations. In such automatic embodiments of a storage system employing out-of-space condition risk mitigation management in accordance with the present description, a storage administrator may be automatically notified and alerted in a notification phase to the fact that a transfer of donor pool storage capacity has been performed by the storage system. As a result of the notification, the system administrator may take appropriate action such as adding new storage capacity to a problematic storage pool in the system. In embodiments in which the donor pool storage capacity transfer is performed manually by a storage administrator, a notification of donor pool transfer action may provide a reminder to a storage administrator to take such appropriate action as a follow-up to the transfer.

In another aspect of out-of-space condition risk mitigation in accordance with the present description, once new storage capacity has been added to a recipient storage pool, the storage capacity donated to the recipient storage pool from a donor pool may no longer be needed by the recipient storage pool for the continuance of I/O operations without disruption. Accordingly, in one embodiment, in response to the adding of new, additional or supplemental storage capacity to the recipient storage pool, any data stored within the storage capacity donated form a donor pool, may be migrated to other storage capacity within the recipient storage pool. Each donated mdisks (and its associated volume donated to the storage pool) may be removed from the recipient storage pool in a reversion phase. In addition, the donated mdisks may be returned to the donor pool or donor pools which provided them in the first place. In this manner, the original storage capacity of a donor pool may be restored in whole or in part and made available for use by other storage pools in which an imminent out-of-space condition is detected.

In another aspect of out-of-space condition risk mitigation in accordance with the present description, donor virtual storage need not be reserved exclusively for emergency transfers. Instead, at least some of the donor virtual storage may be utilized for normal I/O operations if needed. As a result, designating a portion of a storage pool as a donor pool need not reduce available storage capacity of the storage pool if subsequently needed for continuing I/O operations. Storing data in donor storage capacity converts that storage capacity to non-donor storage capacity which is not available for donation to other storage pools.

In one embodiment, measured capacity usage of a storage pool may be compared to a capacity usage warning threshold which may be lower than a donation recipient threshold. If the measured capacity usage of the storage pool exceeds this capacity usage warning threshold before the donation recipient threshold is exceeded, donor pool storage capacity of that storage pool may be converted to non-donor storage capacity in anticipation that the storage pool is likely to run out of available storage capacity itself. Accordingly, donor storage capacity of the storage pool may be converted to non-donor storage capacity by redesignating donor storage capacity as non-donor storage capacity which is no longer available for donation to other storage pools.

In one embodiment, storage pools are arranged in a hierarchical multi-tier storage structure in which each storage pool is assigned to a tier of hierarchical storage. Each tier of the hierarchy typically has a different storage data transfer rate as compared to that of another tier. In another aspect of out-of-space condition risk mitigation in accordance with the present description, a donor pool may be selected from a tier which has a storage data transfer rate which is one of 1) the same as the storage data transfer rate of the tier of the recipient storage pool, and 2) lower than the storage data transfer rate of the tier of the recipient storage pool.

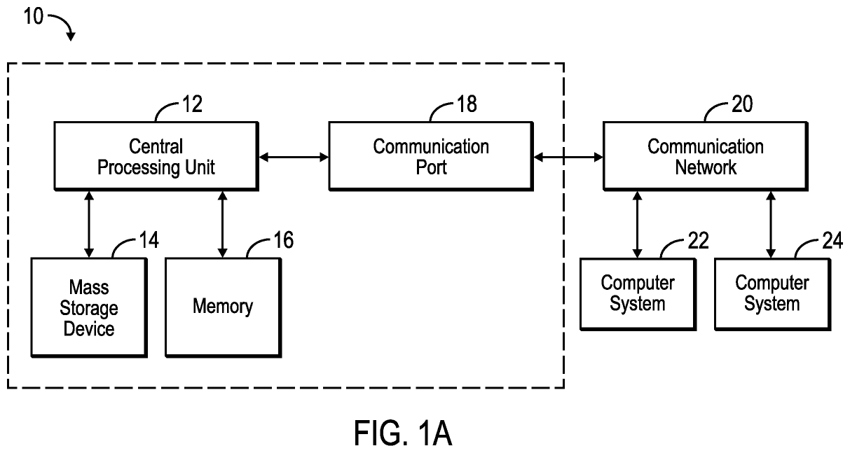

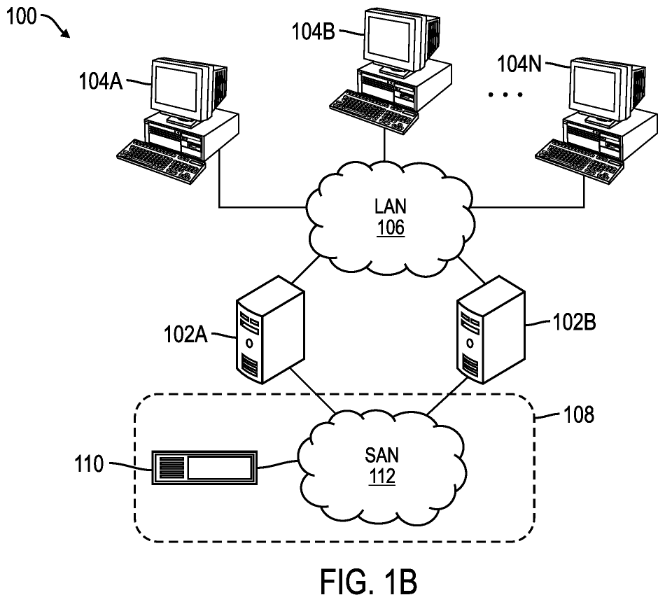

Various aspects of the present disclosure are described below with reference to flowchart illustrations and/or block diagrams of methods, apparatus (system) and computer program products. Turning to FIG. 1A, an example of a computer system 100 is depicted in which aspects of an embodiment of out-of-space condition risk mitigation management in accordance with the present disclosure may be realized. Computer system 10 includes central processing unit (CPU) 12, which is connected to mass storage device(s) 14 and memory device 16. Mass storage devices may include solid state devices such as flash drives and may also include other types of mass storage devices such as hard disk drive (HDD) devices, which may be configured in a redundant array of independent disks (RAID). In the illustrated embodiment, the mass storage devices 14 may include a tape data storage system as well as other mass storage devices.

Memory device 16 may include such memory as random access memory (RAM), electrically erasable programmable read only memory (EEPROM) or a host of related devices. Memory device 16 and mass storage device 14 are connected to CPU 12 via a signal-bearing medium. In addition, CPU 12 is connected through communication port 18 to a communication network 20, having an attached plurality of additional computer systems 22 and 24. The computer system 10 may include one or more processor devices (e.g., CPU 12) and additional storage devices 14 and memory devices 16 for each individual component of the computer system 10.

FIG. 1B is a high-level block-diagram showing a representation of an enterprise computer system in which aspects of an embodiment of out-of-space condition risk mitigation management may be realized. Examples of enterprise-wide applications include, without limitation, banking transactions, payroll, warehouse, transportation, and batch jobs. Enterprise computer system 100 of FIG. 1B comprises a number of host data processing systems (e.g., server data processing systems 102A, 102B and associated workstations or client data processing systems 104A, 104B . . . 104N), which are communicatively coupled together via a first network interconnect (e.g., local area network or “LAN” interconnect 106) as shown. The network 106 may comprise a network such as a Storage Area Network (SAN), Local Area Network (LAN), Intranet, the Internet, Wide Area Network (WAN), peer-to-peer network, wireless network, arbitrated loop network, etc.

Server data processing systems 102A, 102B of the depicted embodiment are further coupled to a storage subsystem 108 including a number of data storage controllers and storage devices 110 and a second network interconnect (e.g., storage area network or “SAN” interconnect 112). One or more of the server data processing systems 102A, 102B, client data processing systems 104A, 104B . . . 104N, and storage system 108 may be configured for out-of-space condition risk mitigation management in accordance with the present description.

In the exemplary embodiment of FIG. 1B, the storage subsystem 108 may include any number and type of devices 110 (e.g., storage controllers, individual disk drives, solid state drives, tape drives, disk arrays, tape arrays, RAID array subsystems, robotic tape libraries, filers, file servers) communicatively coupled together and to server data processing systems 102A, 12B via a storage interconnect (SAN interconnect 112), such as a fiber channel (FC) switch, switch fabric, arbitrated loop, or the like. Server data processing system 102A of the embodiment of FIG. 1B comprises an application server (e.g., a database server) to provide core operational functionality to one or more of client data processing systems 104A-104N (where “N” is a positive integer) and server data processing system 102B comprises another server (e.g., a cluster failover server, load-balancing server, backup server, or the like).

Each communication link may comprise any of a number of communication media capable of transmitting one or more electrical, optical, and/or acoustical propagated signals (e.g., copper wiring, fiber optic cable, or the like) between SAN interconnect 112 and a communication port of data storage devices 110.

In the illustrated embodiment, one or more of the storage controllers of the devices 110 are configured with sufficient functionality to employ out-of-space condition risk mitigation management in accordance with the present description, as will be further described herein. However, it is appreciated that one or more of the computer systems 10, 22, 23 (FIG. 1A), server data processing systems 102A, 102B (FIG. 1B), client data processing systems 104a, 104b . . . 104n, and other devices 110, may be configured to employ out-of-space condition risk mitigation management in accordance with the present description.

The client computer 104A, 104B . . . 104N may comprise a personal computing device, such as a laptop, desktop computer, tablet, smartphone, etc. The server 102A, 102B may comprise one or more server class computing devices, or other suitable computing devices. The systems 100 and 102 may comprise physical machines or virtual machines.

While a conventional SAN-type interconnect (SAN interconnect 112) has been specifically depicted in the embodiment of FIG. 1B, other interconnects (e.g., direct connection, local, metropolitan, and/or wide-area networks) and other protocols (e.g., FICON, ESCON, SSA, or the like) may be utilized. Moreover, while a particular number and arrangement of elements have been illustrated with respect to enterprise 100 of FIG. 1B, it should be appreciated that embodiments of the present disclosure are not limited to enterprises, systems, or data storage devices having any particular number, type, or arrangement of components and so may encompass a wide variety of system types, architectures, and form factors.

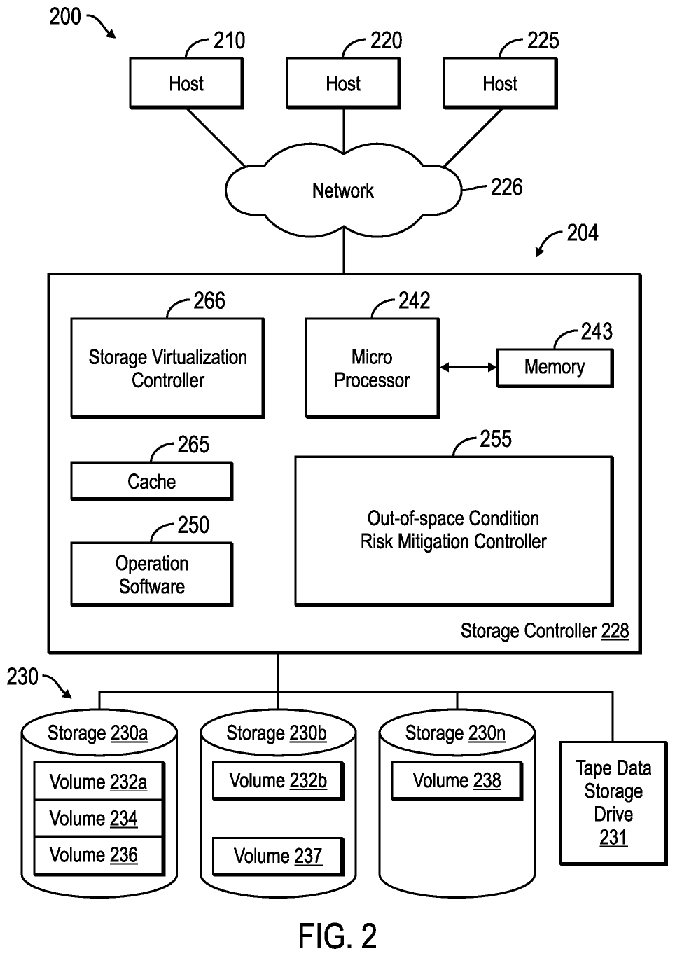

In an alternative embodiment, FIG. 2 is an exemplary computer system 200 showing a hardware and software structure of a data storage system 204 in which aspects of out-of-space condition risk mitigation management in accordance with the present description may be realized. Host computers 210, 220, 225, are shown, each acting as a central processing unit for performing data processing as part of the computer system 200 which includes a data storage system 204. The hosts (physical or virtual devices), 210, 220, and 225 may be one or more physical devices or logical devices to accomplish the purposes of an embodiment of the present disclosure. In one embodiment, by way of example only, a data storage system 204 may be implemented as IBM® System Storage™ DS8000™ which has been modified to employ out-of-space condition risk mitigation management in accordance with the present description.

A Network connection 226 may be a fibre channel fabric, a fibre channel point to point link, a fibre channel over ethernet fabric or point to point link, a FICON or ESCON I/O interface, any other I/O interface type, a wireless network, a wired network, a LAN, a WAN, heterogeneous, homogeneous, public (i.e. the Internet), private, or any combination thereof. The hosts, 210, 220, and 225 may be local or distributed among one or more locations and may be equipped with any type of fabric (or fabric channel) (not shown in FIG. 2) or network adapter to the storage controller 228, such as Fibre channel, FICON, ESCON, Ethernet, fiber optic, wireless, or coaxial adapters. Data storage system 204 is accordingly equipped with a suitable fabric (not shown in FIG. 2) or network to communicate. Data storage system 204 is depicted in FIG. 2 comprising storage controller 228, and storage 230 controlled by the storage controller 228.

Storage 230a,230b . . . 230n of storage 230 may be physically comprised of one or more storage devices, such as storage arrays. A storage array is a logical grouping of individual storage devices, such as a hard disk or a tape data storage drive. In certain embodiments, one or more of storage 230a, 230b . . . 230n is comprised of a JBOD (Just a Bunch of Disks) array or a RAID (Redundant Array of Independent Disks) array. A collection of physical storage arrays may be further combined to form a rank, which dissociates the physical storage from the logical configuration. The storage space in a rank may be allocated into logical volumes, which define the storage location specified in a write/read request. Moreover, a tape data storage device 231 may be implemented with the architecture described in FIG. 2.

In one embodiment, by way of example only, the storage system as shown in FIG. 2 may include a logical volume, or simply “volume,” and may have different kinds of allocations. Storage 230a, 230b and 230n are shown as ranks in data storage system 200, and are referred to herein as rank 230a, 230b and 230n. Ranks may be local to data storage system 200, or may be located at a physically remote location. In other words, a local storage controller may connect with a remote storage controller and manage storage at the remote location. Rank 230a is shown configured with two entire volumes, 234 and 236, as well as one partial volume 232a. Rank 230b is shown with another partial volume 232b and a full volume 237. Thus volume 232 is allocated across ranks 230a and 230b. Rank 230n is shown as being fully allocated to volume 238—that is, rank 230n refers to the entire physical storage for volume 238. From the above examples, it will be appreciated that a rank may be configured to include one or more partial and/or entire volumes. Volumes and ranks may further be divided into so-called “tracks,” which represent a fixed block of storage. A track is therefore associated with a given volume and may be given a given rank.

To facilitate a clearer understanding of aspects of the present disclosure, storage controller 228 is shown in FIG. 2 as a single processing unit, including a microprocessor 242, system memory 243 which may include nonvolatile storage (“NVS”) described in more detail below. It is noted that in some embodiments, storage controller 228 is comprised of multiple processing units, each with their own processor complex and system memory, and interconnected by a dedicated network within data storage system 204. In some embodiments, the devices included in storage 230 may be connected in a loop architecture. Storage controller 228 manages storage 230 and facilitates the processing of write and read requests intended for storage 230. The system memory 243 of storage controller 228 stores program instructions and data, which the processor 242 may access for executing functions and methods of an embodiment of the present disclosure for executing and managing storage 230 as described herein. In one embodiment, system memory 243 includes, in association with, or in communication with the operation software 250, out-of-space condition risk mitigation management or controller 255 for performing methods and operations in accordance with the present description. Out-of-space condition risk mitigation controller 255 may be implemented with one or more of hardware, software, and firmware, alone or in combination, and may be implemented at any of the three storage domain layers: hosts, storage network (e.g., storage routers and storage controllers), and storage devices (e.g., disk arrays).

As shown in FIG. 2, system memory 243 may also include or be in communication with a cache 265 for storage 230, also referred to herein as a “cache memory”, for buffering “write data” and “read data”, which respectively refer to write/read requests and their associated data. In one embodiment, cache 265 is allocated in a device external to system memory 243, yet remains accessible by microprocessor 242 and may serve to provide additional security against data loss, in addition to carrying out the operations as described in herein. In some embodiments, cache 265 is implemented with a volatile memory and nonvolatile memory and coupled to microprocessor 242 via a local bus (not shown in FIG. 2) for enhanced performance of data storage system 200. An NVS portion of the memory 243 included in data storage controller is accessible by microprocessor 242 and serves to provide additional support for operations and execution of an embodiment of the present disclosure as described in other figures. The NVS may also referred to as a “persistent” cache, or “cache memory” and is implemented with nonvolatile memory that may or may not utilize external power to retain data stored therein. The NVS may be stored in and with the cache 265 for any purposes suited to accomplish the objectives of an embodiment of the present disclosure. In some embodiments, a backup power source (not shown in FIG. 2), such as a battery, supplies NVS with sufficient power to retain the data stored therein in case of power loss to data storage system 200. In certain embodiments, the capacity of NVS is less than or equal to the total capacity of cache 265.

The storage controller 228 includes a virtualization controller 266 which in this embodiment, is a network based storage virtualization system for managing large amounts of heterogeneous data storage in an enterprise data center. Data virtualization is a technology that makes one set of resources look and feel like another set of resources, preferably with more desirable characteristics. The virtualized resources are a logical representation of the original resources that are not constrained by physical limitations, variations, and complexity. A storage virtualization shifts the management of data storage from physical volumes of data to logical volumes of data, and may be implemented at various layers within the I/O stack such as at the disk layer and at the file system layer. A virtualization at the disk layer is referred to as a block-level virtualization or a block aggregation layer. A block-level virtualization may be implemented at any of the three storage domain layers: hosts, storage network (e.g., storage routers and storage controllers), and storage devices (e.g., disk arrays).

For data storage, virtualization may include the creation of a storage pool based upon several disk or other storage devices. The pool can be organized into virtual disks (Vdisks) or image-mode disks that are visible to the host systems using the disks. Vdisks can use mixed back-end storage and provide a common way to manage a storage area network (SAN).

An example of data storage products that provide block-level virtualization is the IBM® SAN Volume Controller (SVC) product model 2145. A SAN virtualization system may be implemented as a clustered appliance in the storage network layer. A fundamental concept of data storage virtualization is to decouple data storage from the storage functions required in a storage area network (SAN) environment. Decoupling means abstracting the physical location of data from the logical representation of the data. A storage virtualization device may present logical entities to the users and internally manage the process of mapping these entities to the actual location of the physical storage. The actual mapping performed is dependent upon the specific implementation, as is the granularity of the mapping, which can range from a small fraction of a physical disk, up to the full capacity of a physical disk, for example.

A single block of information in this environment is identified by its logical unit number (LUN) which is the physical disk, and an offset within that LUN which is known as a logical block address (LBA). The term physical disk is used in this context to describe a unit of storage that might be part of a RAID array in the underlying disk subsystem. Specific to a SAN virtualization controller implementation, the address space that is mapped by the logical entity is referred to as volume, and the physical disk is referred to as managed disks (e.g., Mdisks).

In one embodiment, the server and application are only aware of the logical entities, and may access these entities using an interface provided by the virtualization layer such as the SCSI interface. The functionality of a volume that is presented to a server, such as expanding or reducing the size of a volume, mirroring a volume, creating a FlashCopy®, thin provisioning, and so on, is implemented in the virtualization layer. It does not rely in any way on the functionality that is provided by the underlying disk subsystem. Data that is stored in a virtualized environment is stored in a location-independent way, which allows a user to move or migrate data between physical locations.

A block-level storage virtualization in a SAN virtualization controller provides many benefits such as allowing online volume migration while applications are running, simplifying storage management by providing a single image for multiple controllers and a consistent user interface for provisioning heterogeneous storage, and providing enterprise-level copy services functions. In addition, storage utilization can be increased by pooling storage across the SAN, and system performance is improved as a result of volume striping across multiple arrays or controllers and the additional cache that a SAN virtualization controller provides.

A SAN virtualization controller may manage a number of back-end storage controllers or locally attached disks and map the physical storage within those controllers or disk arrays into logical disk images or volumes, which are seen by application servers and workstations in the SAN. The SAN may be zoned so that the application servers cannot see the back-end physical storage, which prevents any possible conflict between the SAN virtualization controller and the application servers both trying to manage the back-end storage.

Each virtualization controller hardware unit may be referred to as a node. The node provides the virtualization for a set of volumes, cache, and copy services functions. Storage nodes in a virtualization controller may be deployed in pairs and multiple pairs make up a cluster. In current virtualization controllers, a cluster may consist of multiple node pairs or I/O groups. All configuration, monitoring, and service tasks in a virtualization controller may be performed at the cluster level. Configuration settings may be replicated to all nodes in the cluster.

The cluster and its I/O groups may view the storage that is presented by back-end controllers as a number of disks or LUNs, known as managed disks or Mdisks. An Mdisk is usually provisioned from a RAID array. The application servers, however, do not see the Mdisks. Instead they see a number of logical disks, known as virtual disks or volumes, which are presented by the cluster's I/O groups through a SAN (e.g., through a Fibre Channel protocol) or LAN (e.g., through an iSCSI protocol) to the servers. Each Mdisk presented from an external disk controller has an online path count that is the number of nodes having access to that Mdisk. The maximum count is the maximum paths detected at any point in time by the cluster.

Volumes are thus logical disks presented to the hosts or application servers by a virtualization controller. When a host performs I/Os to one of its volumes, all the I/Os for a specific volume are directed to one specific I/O group in the cluster. The virtualization controller may present a volume to a host through different ports in the virtualization controller, thus providing redundant paths to the same physical storage devices. Redundant paths or multi-paths establish two or more communication connections between a host system and the storage device that it uses. If one of these communication connections fails, another communication connection is used in place of the failed connection. The allocation and management of the multiple paths to the same storage devices may be handled by multi-path software.

FIG. 3 shows an example of a storage pool 302 which may be modified for employment with out-of-space condition risk mitigation management in accordance with the present description. In this example, the storage pool 302 is created in unmodified form as a logical container 304 that groups together various managed disks (referred to herein as “mdisks”) as represented by the mdisks 306₁, 306₂ . . . 306_{N} (where N is a positive integer), each of which is a building block of usable storage capacity. The actual storage capacity of an mdisk is provided by block storage of physical storage that may be virtualized from internal or external physical storage or provided directly by physical storage 230 (FIG. 2) such as a RAID array, for example. Storage pools such as the storage pool 302 may be created in unmodified form using known techniques or techniques which may be subsequently developed.

FIG. 4 depicts an example of the virtualization of a block 402 of physical storage. In this example, the storage virtualization controller 266 maps (as represented by the arrow 404), a unit of virtual storage such as an mdisk 306 (of the mdisks 306₁, 306₂ . . . 306_{N} (FIG. 3) to the block 402 of physical storage. As volumes of virtual storage are allocated to a host, the storage virtualization controller 266 maps (as represented by the arrow 406), each such volume as represented by the volume 238 (FIG. 2) to a unit of virtual storage such as the mdisk 306, which is in turn mapped to the block 402 of physical storage as noted above. Physical storage may be virtualized using a variety of known techniques and techniques which may be subsequently developed.

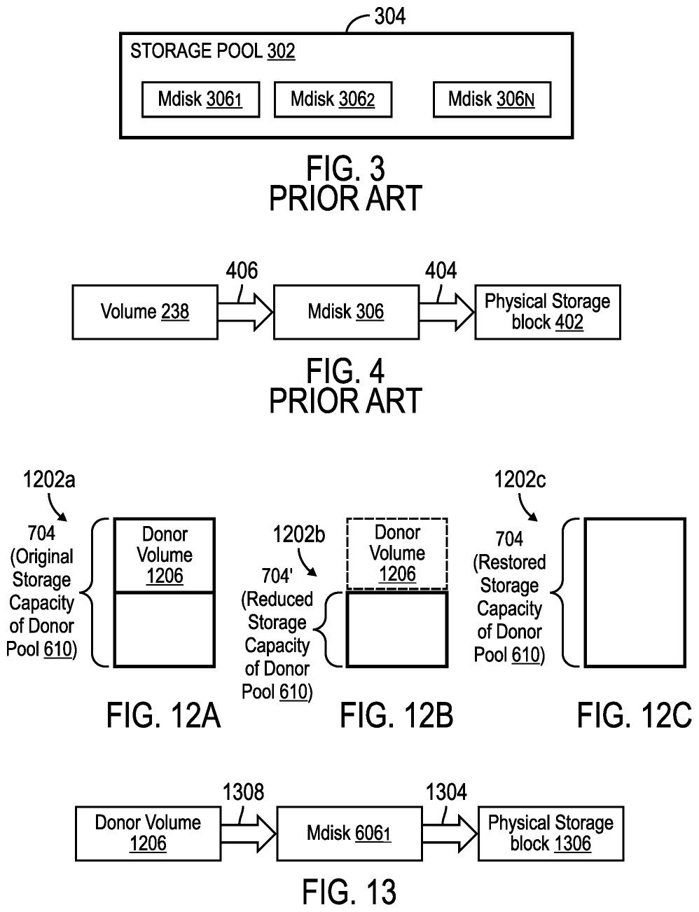

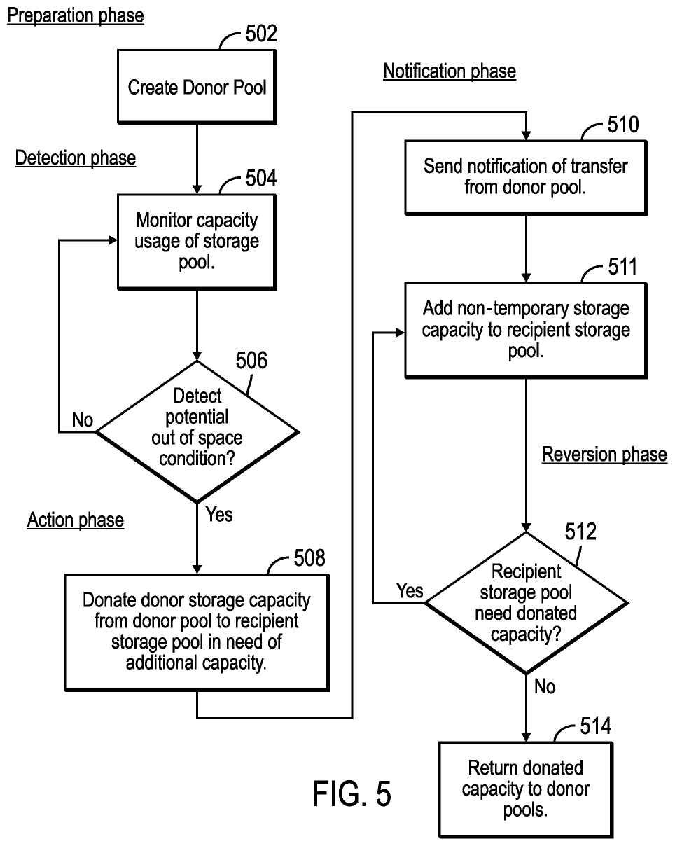

FIG. 5 depicts one example of operations of the out-of-space condition risk mitigation controller 255 (FIG. 2) of a storage system in accordance with one embodiment of the present description. As shown in FIG. 5, the operations of controller 255 (FIG. 2) in this example are represented by blocks 502-514 of FIG. 5, and include five phases, that is, a preparation phase, a detection phase, an action phase, a notification phase and a reversion phase. It is appreciated that the number and types of phases of operation of an out-of-space condition risk mitigation controller 255 (FIG. 2) in accordance with embodiments of the present description, may vary, depending upon the particular application.

In the preparation phase of this example, a donor pool is created (block 502, FIG. 5) by first creating a storage pool and designating a portion of the storage capacity of the storage pool as a donor pool. In one aspect of out-of-space condition risk mitigation of the present description, the donor pools may be created prior to detection of a potential out-of-space condition. As a result, donor storage capacity storage is readily available for transfer to a recipient storage pool which may need it to avoid an out-of-space condition. However, as explained in greater detail below, designating a portion of a storage pool as a donor pool, need not reduce the storage capacity of that storage pool for regular I/O operations.

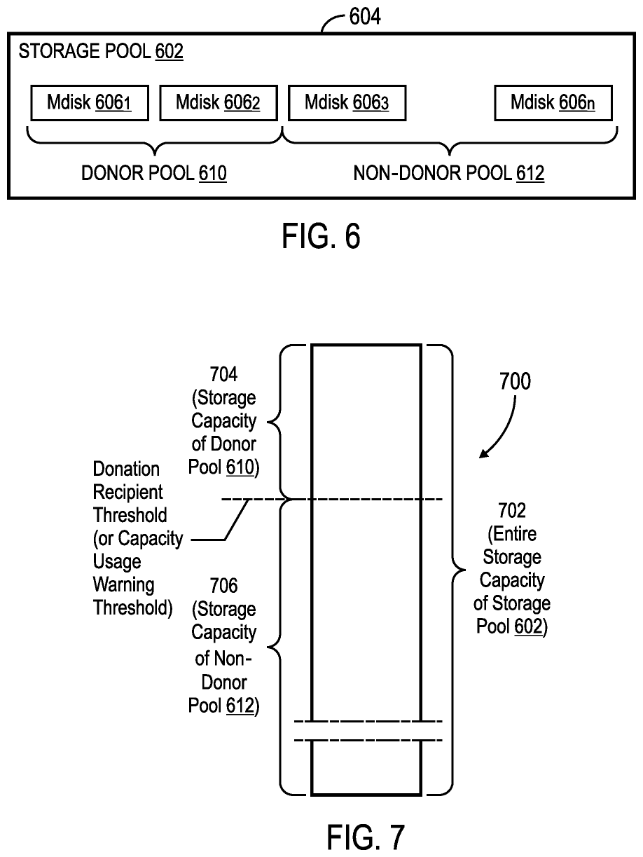

FIG. 6 shows an example of such a storage pool 602 which like the storage pool 302 of FIG. 3, is created as a logical container 604 that groups together various managed disks (referred to herein as “mdisks”) as represented by the mdisks 606₁, 606₂, 606₃ . . . 606ₙ (n is a positive integer), each of which is a building block of usable storage capacity. The storage pool 602 may be created in its initial form using known storage pool creation techniques or using such techniques as may be subsequently developed. However, in accordance with one aspect of out-of-space condition risk mitigation management of the present description, one or more of the mdisks 606₁, 606₂, 606₃ . . . 606ₙ is designated to provide storage for a donor pool 610 which is a sub-pool of the storage pool 602. In the example of FIG. 6, the mdisks 606₁, 606₂, are designated to provide storage capacity referred to herein as donor storage capacity, of the donor pool 610. As explained in greater detail below, some or all of the donor storage capacity of the donor pool 610 may be temporarily donated to another storage pool, referred to herein as a “recipient storage pool,” to mitigate risk of a possible out-of-space condition in the recipient storage pool if needed.

In this example, the remaining mdisks 606₃ . . . 606ₙ of the storage pool 602 are designated to provide storage capacity for the storage pool 602 itself rather than donor storage capacity for emergency use by another storage pool. Accordingly, the remaining mdisks 606₃ . . . 606ₙ of the storage pool 602 are grouped to comprise a non-donor pool or sub-pool 612 of the storage pool 602. Although the donor pool 610 is depicted in this example as including two mdisks 606₁, 606₂, for purposes of clarity, it is appreciated that the number of mdisks of the storage pool 602 which are designated for a donor pool or a non-donor pool, may vary, depending upon the particular application. As previously mentioned, the actual storage capacity of an mdisk is provided in this example by blocks of physical storage that may be virtualized from internal or external physical storage or provided directly by physical storage 230 (FIG. 2) such as a RAID array, for example.

FIG. 7 represents in graphical form 700 the storage capacity of the storage pool 602. The entire storage capacity provided by all the mdisks 606₁, 606₂, 606₃ . . . 606ₙ (FIG. 6) of the storage pool 602 is indicated at 702. As shown in FIG. 7, a portion 704 of the full storage capacity 702 of the storage pool 602 is designated as donor storage capacity of the donor pool 610 of the storage pool 602. In one embodiment, a percentage such as 5%, for example, of the entire storage capacity 702 of the storage pool 602 may be designated as donor storage capacity 704 for the donor pool 610 of the storage pool 602. Thus, if the full storage capacity 702 of the storage pool 602 is 50 tebibytes (TiB), for example, the donor storage capacity 704 designated for the donor pool 610 would be 2.5 TiB, with the remaining 47.5 TiB of storage capacity of the storage pool 602 being designated for the non-donor pool 612 as represented by the portion 706. It is appreciated that the amount of storage capacity designated for a storage pool, and its donor and non-donor pools of that storage pool, may vary depending upon the particular application. Similarly, it is appreciated that the percentage of storage capacity of a storage pool which is designated for the donor pool portion versus the non-donor pool portion of that storage pool, may vary, depending upon the particular application.

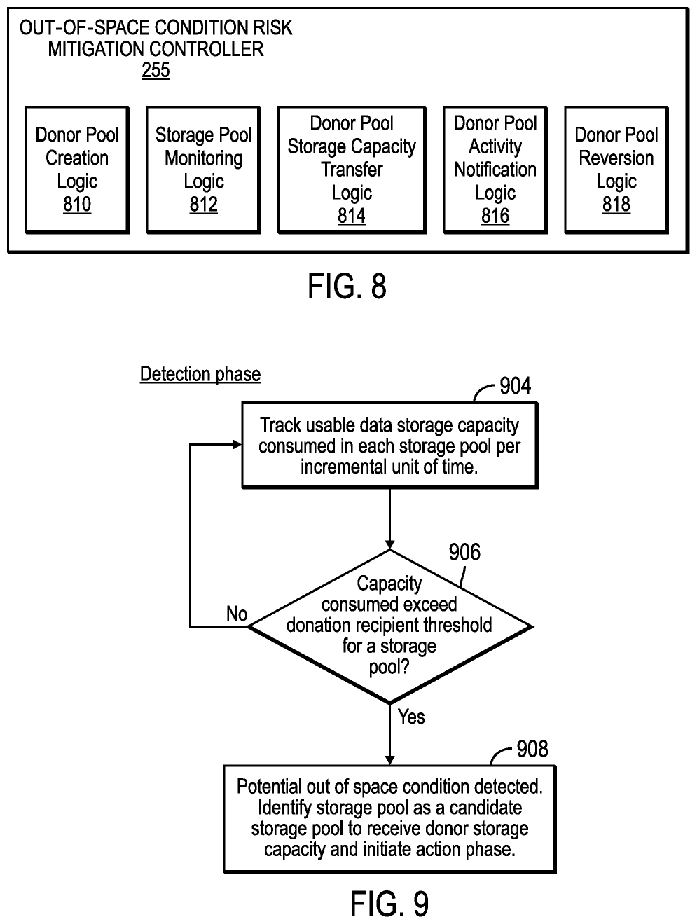

FIG. 8 depicts a more detailed embodiment of the out-of-space condition risk mitigation controller 255 which includes logic elements or controllers 810, 812, 814, 816 and 818. In one embodiment, a donor pool may be created (block 502, FIG. 5) by a storage system administrator utilizing resources of a donor pool creation logic 810 (FIG. 8) of the out-of-space condition risk mitigation controller 255. For example, the donor pool creation logic 810 may provide prompts through graphical and textual user interfaces at a suitable workstation 104a (FIG. 1B) for the storage system administrator to provide values for various input parameters to control the donor pool creation process. These input parameters may include, for example, a value defining the percentage of storage capacity of each storage pool being created to designate for a donor pool of each such storage pool. Other input parameters may include various threshold values as described below to govern the out-of-space condition risk mitigation process. Still other input parameters may include the number or selection of particular mdisks to be grouped in each storage pool and its associated donor pool being created.

Once values for the donor pool creation input parameters have been identified by the storage system administrator, in one embodiment, the donor pool creation logic 810 (FIG. 8) can proceed automatically in one embodiment, to create the storage pools and their associated donor pools without further participation by the storage system administrator. In other embodiments, the donor pool creation logic 810 (FIG. 8) can proceed in a fully automatic fashion to automatically create the donor and storage pools without substantial participation by the storage system administrator. For example, the donor pool creation logic 810 (FIG. 8) can rely upon predetermined default values for the donor pool creation input parameters to obviate manual input of values for these parameters by the storage system administrator. However, in one embodiment, the storage system administrator can override preprogrammed default values if needed.

Upon creating one or more donor pools as described above in connection with the preparation phase, the controller 255 of the storage system in the detection phase (FIG. 5), monitors (block 504, FIG. 5) the data storage capacity usage in the various storage pools of the storage system and determines when to initiate the subsequent action phase. In this example, the storage system controller 255 initiates the action phase when a potential out-of-space condition is detected (block 506, FIG. 5) in a storage pool being monitored (block 504, FIG. 5) in the detection phase.

In one embodiment, data storage capacity usage in the various storage pools of the storage system, may be monitored by storage pool monitoring logic 812 (FIG. 8) of the out-of-space condition risk mitigation controller 255. The storage pool monitoring logic 812 (FIG. 8) may monitor data storage capacity usage using known storage pool monitoring techniques or using such techniques as may be subsequently developed. However, in accordance with one aspect of out-of-space condition risk mitigation management of the present description, monitoring data storage capacity usage in the storage pools of the storage system is modified in the detection phase to initiate an action phase as described below, in response to detection (block 506, FIG. 5) of a potential or imminent out-of-space condition.

FIG. 9 depicts a more detailed example of operations 904-908 of the storage pool monitoring logic 812 (FIG. 8) in the detection phase. In this example, the monitoring logic 812 (FIG. 8) of the storage system keeps track (block 904, FIG. 9) of the usable capacity consumed in each of the storage pools per time increment. If it is determined (block 906, FIG. 9) that the data storage capacity consumed by a particular storage pool exceeds a donation recipient threshold (also referred to herein as a capacity usage warning threshold) for a storage pool, a potential out-of-space condition is detected (block 908, FIG. 9).

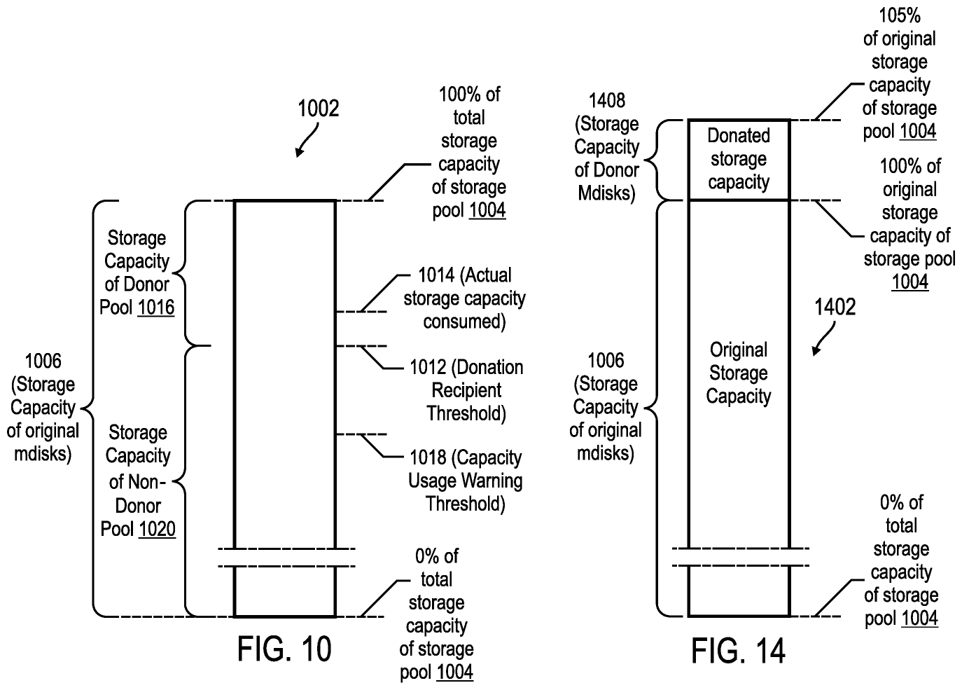

FIG. 10 represents in graphical form 1002, the storage capacity of a storage pool 1004 being monitored by monitoring logic 812 (FIG. 8) of the storage system. The entire storage capacity of the storage pool 1004 which is provided by all the original mdisks contained in a storage pool 1004, is indicated at 1006. Actual storage capacity consumed by data stored in the storage pool 1004 may range from 0% indicated at the bottom end of the storage capacity representation 1002, to 100% of storage capacity indicated at the top end of the representation 1002. In this example, a donation recipient threshold within the storage capacity of the storage pool 1004 is indicated at 1012 in FIG. 10. The donation recipient threshold 1012 if exceeded, provides a capacity usage warning that a potential or imminent out-of-space condition has been detected. In one embodiment, the donation recipient threshold may be set at a certain percentage of the full storage capacity of the storage pool 1004. For example, the donation recipient threshold may be set at 95% of the entire storage capacity of the storage pool 1004. It is appreciated that the donation recipient threshold may be set at other percentages of the entire storage capacity of a storage pool, depending upon the particular application.

In the example of FIG. 10, the amount of data storage capacity which has actually been consumed in the storage pool 1004 by writing and storing data in the storage pool 1004, is indicated at 1014. As shown in FIG. 10, in this example, the data storage capacity consumed at the point in time represented by the depiction of FIG. 10, exceeds the donation recipient threshold 1012 for the storage pool 1004. In this manner, an impending out-of-space condition may be detected (block 908, FIG. 9) for the storage pool 1004. Accordingly, the storage pool 1004, is identified (block 908, FIG. 9) as a candidate recipient storage pool to receive additional data storage capacity which can be donated as donor storage capacity from a donor pool of another storage pool in the action phase described below. Thus, the action phase is initiated (block 908, FIG. 9) in response to detection of an impending out-of-space condition and selection of a candidate recipient storage pool.

The detection phase described above for the storage pool 1004 may be repeated for each storage pool of the storage system for purposes of detecting whether there are any potential or imminent out-of-space conditions present in each storage pool of the storage system. If so, the action phase (FIG. 5) is initiated (block 908) for each such storage pool which has been identified (block 908, FIG. 9) as a candidate recipient storage pool to receive donated data storage space from a donor pool of another storage pool.

In this example, the data storage capacity consumed at the point in time of FIG. 10 includes a portion of the storage capacity previously provided by the original donor pool 1016 of the storage pool 1004. Thus, in one aspect of out-of-space condition risk mitigation management in accordance with the present description, the storage capacity previously provided by the donor pool 1016 is available for storing data in normal I/O operations to the extent there is remaining donor storage capacity which has not been donated to other storage pools.

In one embodiment, any available storage capacity of the donor pool 1016 not yet donated to another storage pool, may be converted to non-donor status as appropriate to prevent future donation of donor storage capacity from the storage pool 1004 as consumption of the storage capacity of the storage pool 1004 approaches the donation recipient threshold 1012. For example, an earlier capacity usage warning threshold indicated at 1018 may be provided at 80%, for example, of total storage capacity of the storage pool 1004. If the measured actual storage capacity consumed exceeds the capacity usage warning 1018, any donor storage capacity of the donor pool may be re-designated as no longer available for potential use by other storage pools. Thus, the storage capacity of the donor pool can be converted to non-donor storage capacity to help preserve usable capacity in a storage pool that is itself approaching an out-of-space condition. Thus, the non-donor storage capacity converted from the donor pool 1016 may supplement the original storage capacity of the original non-donor pool 1020.

In the illustrated embodiment, the donation recipient threshold indicated at 1012 and the capacity usage warning indicated at 1018, are set at 95% and 80%, respectively of the total storage capacity of the storage pool 1004. It is appreciated that thresholds may be set at other values, depending upon the particular application.

In one embodiment, the storage pool monitoring logic 812 (FIG. 8) can proceed substantially automatically without substantial participation by the storage system administrator, to monitor capacity usage of the storage pools as described above in connection with FIGS. 5, 9 and 10. In other embodiments, a system administrator can use resources of the storage pool monitoring logic 812 (FIG. 8) to manually monitor capacity usage of the storage pools as described above in connection with FIGS. 5, 9 and 10. For example, the storage pool monitoring logic 812 (FIG. 8) can provide graphical and textual user interfaces at a suitable workstation 104a (FIG. 1B) to convey to a system administrator the current status of capacity usage relative to donation recipient thresholds for the storage pools of the storage system and facilitate manual identification of candidate recipient storage pools as donation recipient thresholds are exceeded, in accordance with those operations described above in connection with FIGS. 5, 9 and 10

As noted above, the storage system initiates the action phase when a potential out-of-space condition is detected (block 506, FIG. 5) in a storage pool being monitored (block 504, FIG. 5). In this example, in response to detecting (block 506, FIG. 5) one or more storage pools as having a potential or imminent out-of-space condition, the storage system in the action phase, donates (block 508, FIG. 5) additional (that is, donor) data storage capacity from one or more donor pools of other storage pools to each storage pool having been identified as being candidate recipient storage pool, to mitigate the potential or imminent out-of-space condition of each such problematic storage pool. In one embodiment, data storage capacity may be donated from donor pools to different storage pools needing additional storage capacity, by donor pool storage capacity transfer logic 814 (FIG. 8) of the out-of-space condition risk mitigation controller 255. As explained below, the donor pool storage capacity transfer logic 814 (FIG. 8) donates donor storage capacity by taking storage capacity from a donor pool of one storage pool, and transferring the donor storage capacity to the problematic storage pool needing additional storage capacity. Thus, in one aspect of out-of-space condition risk mitigation management in accordance with the present description, the storage pool which contains the donor pool, and the recipient storage pool receiving storage capacity from the donor pool, are different storage pools in one embodiment.

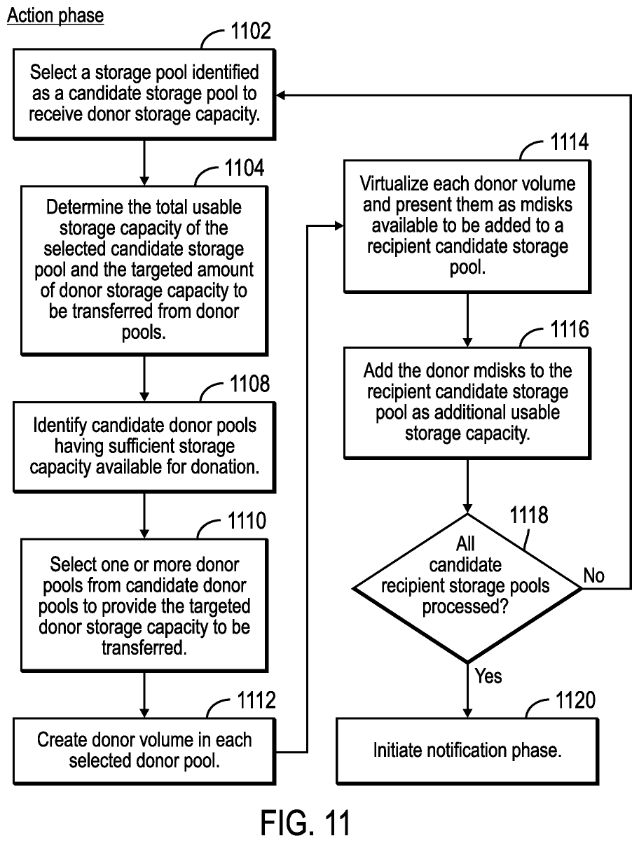

FIG. 11 depicts a more detailed embodiment of the action phase in which donor data storage capacity is donated (block 508, FIG. 5) by the donor pool storage capacity transfer logic 814 (FIG. 8) from one or more donor pools to a recipient storage pool. As shown in FIG. 11, the action phase operations of the donor pool storage capacity transfer logic 814 (FIG. 8) in this example are represented by blocks 1102-1120. It is appreciated that the number and types of action phase operations by the donor pool storage capacity transfer logic 814 (FIG. 8) of an out-of-space condition risk mitigation controller 255 (FIG. 2) in accordance with embodiments of the present description, may vary, depending upon the particular application.

In one aspect of out-of-space condition risk mitigation management in accordance with the present description, operations of the action phase may selectively be performed either automatically or manually depending upon various factors including whether appropriate storage system administrator notification features of the storage system have been enabled. For example, if the storage administrator has set up Call Home notifications or email notification in the storage system and has already designated which pools are donor pools, emergency donor storage capacity may be transferred automatically from donor pools and an appropriate notification may be sent to storage system administrators notifying them that storage space has been donated by donor pools. Call Home is a communication link between IBM® storage systems, IBM Support, and IBM Storage Insights that monitors the health and status of a storage system and their components and issues alerts and reports which report storage events as they occur. It is appreciated that other storage system notification techniques may be employed to facilitate automatic out-of-space condition risk mitigation management in accordance with the present description.

In this embodiment, the donor pool storage capacity transfer logic 814 (FIG. 8) of the storage system reviews each of the storage pools designated in the detection phase as candidate recipients for emergency storage capacity addition. Accordingly, an initial candidate storage pool is selected (block 1102, FIG. 11) and a determination (block 1104, FIG. 11) is made of the total usable storage capacity of the selected candidate storage pool and the amount of temporary donor storage capacity to be targeted for transfer from donor pools. The initial total usable storage capacity of the selected candidate storage pool is typically known when the storage pool is initially created. However, it is appreciated that the total usable storage capacity of the selected candidate storage pool may have been changed to a different amount by earlier actions of the storage system administrator or by prior donations from a donor pool. Hence, in one embodiment, a determination (block 1104, FIG. 11) is made of the total usable storage capacity of the selected candidate storage pool currently existing upon the initiation of this action phase.

In one embodiment, an attempt will be made by the storage system to increase the determined total usable storage capacity of the selected candidate storage pool by a targeted amount which may be expressed as a percentage, such as 5%, for example, of the current total usable storage capacity of the selected candidate storage pool for example. Thus, if a selected candidate recipient storage pool currently has a total storage capacity of 50 TiB, for example, an attempt will be made in the action phase to increase the total usable storage capacity of the selected candidate storage pool by 5% or 2.5 TiB, for example, using available donor storage capacity provided by one or more donor pools. It is appreciated that the targeted percentage increase of storage capacity of a candidate storage pool may vary, depending upon the particular application.

Having determined an appropriate amount of donor storage capacity to be added to a candidate recipient storage pool, donor pools may be reviewed by the donor pool storage capacity transfer logic 814 (FIG. 8) to identify (block 1108, FIG. 11) candidate donor pools having sufficient storage capacity available for donation to meet the target goal of adding 2.5 TiB in this example, to the candidate recipient storage pool. In one embodiment, the donor capacity to be donated to a particular candidate recipient storage pool can come from several different candidate donor pools if necessary.

Suitable candidate donor pools may be identified using a variety of different selection criteria. For example, in one embodiment, if the storage pools are arranged in hierarchical storage tiers, it may be preferred to limit candidate donor pools to donor pools which are contained by storage pools which are in the same or lower hierarchical storage tier as the tier of the candidate recipient storage pool. In a hierarchical storage system, storage pools are placed in tiers in which the storage pools of one tier typically employ storage devices having a faster I/O rate (and are typically more expensive) as compared to the storage devices employed by storage pools in a lower tier. Thus, as stored data becomes less frequently accessed, the stored data is typically migrated to a lower tier of slower, less expensive storage pools in a hierarchical storage system. It is appreciated that candidate donor pools may be selected from higher storage tiers in some applications.

Suitable candidate donor pools may also be identified by giving priority to donor pools contained by storage pools which are themselves the least likely to require a donation of temporary storage capacity in the near future. For example, a prediction may be made as to when a particular storage pool is likely to require a donation of temporary storage capacity based on the current amount of storage capacity used in the storage pool, and the current rate of storage capacity usage for the storage pool. Candidate donor pools may be identified from those donor pools contained within storage pools that are predicted to be the least likely to require a temporary capacity donation the soonest. It is appreciated that suitable candidate donor pools may be identified using other selection criteria, depending upon the particular application.

Having identified (block 1108, FIG. 11) candidate donor pools, one or more donor pools may be selected (block 1110, FIG. 11) by the donor pool storage capacity transfer logic 814 (FIG. 8) to provide the targeted donor storage capacity for transfer to the candidate recipient storage pool. Thus, for each of the selected donor pools, a determination is made as to how much capacity from that donor pool needs to be donated to meet the total targeted amount of storage capacity to be donated. Thus, in this example, a sufficient number of donor pools are selected from the candidate donor pools to provide a collection of donor storage capacities which add up to an amount sufficient to provide the targeted 5% increase in the storage capacity of the recipient storage pool.

Having selected an appropriate number of suitable donor pools, the donor pool storage capacity transfer logic 814 (FIG. 8) of the out-of-space condition risk mitigation controller 255 (FIG. 2) causes the storage virtualization controller 266 (FIG. 2) to create (block 1112, FIG. 11) a donor volume which may span one or more selected donor pools. FIG. 12A depicts a graphical representation 1202a of the storage capacity of a selected donor pool. In this example, a selected donor pool is the donor pool 610 (FIGS. 6, 7), the original storage capacity of which is indicated at 704 (FIGS. 7, 12A). Within the storage capacity 704 of the donor pool 610, a donor volume 1206 is created. In one embodiment, the created donor volume 1206 may be a “thin-provisioned” volume so that capacity from the donor pool is consumed only if the data written into the recipient pool actually consumes the donated space. A donor volume may be created in a similar fashion for each donor pool selected to donate storage capacity to the recipient storage pool needing additional storage capacity to avoid an out-of-space condition. Alternatively, a donor volume may span more than one donor pool needed to provide the targeted donor storage capacity.

Having created a donor volume in one or more donor pools selected to donate storage capacity, each such created donor volume may be internally virtualized (block 1114, FIG. 11) within the context of the storage system. FIG. 13 depicts an example of the virtualization of a donor volume such as the donor volume 1206, of the donor pool 610 (FIG. 12A), for example. In this example, the storage virtualization controller 266 previously mapped (as represented by the arrow 1304), an original mdisk 606₁ (FIGS. 6, 13) of the donor pool 610 to an existing block 1306 (FIG. 13) of physical storage of the storage system. In addition, the donor pool storage capacity transfer logic 814 (FIG. 8) of the out-of-space condition risk mitigation controller 255 (FIG. 2) causes the storage virtualization controller 266 (FIG. 2) to also map (as represented by the arrow 1308), the donor volume 1206 of the donor pool 610 to a unit of virtual storage such as the mdisk 606₁ (FIGS. 6, 13) which is mapped to the block 1306 of physical storage as described above. It is appreciated that donor volumes may be virtualized using other virtualization techniques, depending upon the particular application.

Having virtualized each donor volume to one or more mdisks in this manner, each virtualized donor volume may be presented (block 1114, FIG. 11) as donor mdisks available to be added to the recipient storage pool. Accordingly, the donor mdisks may be added (block 1116, FIG. 11) by the donor pool storage capacity transfer logic 814 (FIG. 8) of the out-of-space condition risk mitigation controller 255 (FIG. 2), to the recipient candidate storage pool to provide added usable storage capacity provided by the blocks of physical storage mapped to those donor mdisks presented to the candidate recipient storage pool.

As each mdisk mapped to a donor volume is transferred from a donor pool, the storage capacity of the donor pool is correspondingly reduced by the storage capacity of the mdisk (or mdisks) mapped to that donor volume. FIG. 12B depicts such a reduction in the storage capacity of the donor pool 610 in graphical form 1202b. As shown therein, the storage capacity of the donor pool 610 has been reduced as indicated at 704′ in FIG. 12B. More specifically, the storage capacity of the donor pool 610 has been reduced by the transfer of the storage capacity of the mdisk 606₁ (FIG. 13) mapped to the donor volume 1206 (represented in phantom in FIG. 12B) which was transferred from the donor pool 610.

Conversely, as a donor volume or volumes are transferred to a recipient storage pool, the storage capacity of the recipient storage pool is correspondingly increased by the storage capacity of the mdisk (or mdisks) mapped to the donor volume (or volumes) donated the recipient storage pool. FIG. 14 depicts in graphical form 1402 such an increase in the storage capacity of the recipient storage pool 1004. As shown therein, the storage capacity of the storage pool 1004 has been increased from that provided by the original storage capacity of the original mdisks as indicated at 1006 which represents 100% of the original storage capacity, to 105% of the original storage capacity. In this example, the added 5% of storage capacity is provided by the donated storage capacity of the added donor mdisks as indicated 1408, and can reduce or eliminate the likelihood of an impending out of space condition.

As noted above, in this embodiment, the donor pool storage capacity transfer logic 814 (FIG. 8) of the storage system reviews each of the storage pools designated in the detection phase as candidate recipients and processes them for emergency storage capacity addition using donor pools. Accordingly, the donor pool storage capacity transfer logic 814 (FIG. 8) of the storage system determines (block 1118, FIG. 11) whether all candidate recipient storage pools have been reviewed and processed. If not, control returns to block 1102 to select another storage pool identified as a candidate recipient storage pool for processing as described above. In this embodiment, once all candidate recipient storage pools have been processed by adding emergency temporary storage capacity, the notification phase of FIG. 5 is initiated (block 1120, FIG. 11). It is appreciated that in other embodiments, a notification phase may be initiated immediately after each candidate recipient storage pool has been processed by adding emergency temporary storage capacity.

As noted above, in one aspect of out-of-space condition risk mitigation management in accordance with the present description, operations of the action phase may selectively be performed either automatically or manually depending upon various factors. For example, automatic operations may be facilitated by the storage administrator initially enabling appropriate storage system administrator notification features of the storage system. In addition, automatic operations may be facilitated by identifying the various donor pools which have been created. Thus, in the example of FIG. 11, each of the operations 1102-1120 of FIG. 11 may be executed substantially automatically by the donor pool storage capacity transfer logic 814 (FIG. 8) of the out-of-space condition risk mitigation controller 255 (FIG. 2) without little or no participation by a storage system administrator.

Conversely, in a full or partial manual mode, one or more of the operations 1102-1120 of FIG. 11 may be executed substantially manually by a storage system administrator. For example, the donor pool storage capacity transfer logic 814 (FIG. 8) may provide prompts through graphical and textual user interfaces at a suitable workstation 104a (FIG. 1B) for the storage system administrator to provide values for various input parameters to control the donor pool storage capacity transfer process. These input parameters may include, for example, one or more of values for selection (block 1102, FIG. 11) of candidate recipient storage pools to be processed, values for determination (block 1104, FIG. 11) of a targeted amount of donor storage capacity, values for identifying (block 1108, FIG. 11) candidate donor pools, values for selecting donor pools to provide a targeted amount of storage capacity, values for creating (block 1112, FIG. 11) a donor volume in selected donor pools, values for virtualizing each donor volume and presenting them as mdisks available to be added to a recipient storage pool, and values for adding (block 1116, FIG. 11) mdisks to a recipient storage pool to provide a temporary emergency increase in storage capacity for the recipient storage pool. It is appreciated that manual control of one or more of the operations of FIG. 11 may utilize other administrator supplied inputs, depending upon the particular application.

It is further appreciated that in a manual mode of action phase, delays may be experienced as the storage system awaits input and other actions from the system administrator. Accordingly, in one embodiment, while the system is waiting on the storage system administrator to act, I/O to the volumes in a problematic pool which has been designated as a candidate recipient storage pool, may be throttled down, for example, or may be converted to read only mode, for example, so that all the space in the candidate recipient storage pool is not fully consumed.

Returning to FIG. 5, following the action phase, a notification is sent (block 510, FIG. 5) in the notification phase to the appropriate entity, such as the storage system administrator, for example, notifying that action has taken place in which donor storage has been added to one or more recipient storage pools as discussed above. For example, the user may be notified that the storage system has entered into a condition where space from one pool is temporarily in use by another pool on an emergency basis.

In one embodiment, the notification of donor pool transfer activity is performed by donor pool activity notification logic 816 (FIG. 8) of the out-of-space condition risk mitigation controller 255. For example, the donor pool activity notification logic 816 (FIG. 8) may issue the notification of donor pool activity automatically to a system administrator in response to a donation (block 508, FIG. 5) of donor pool storage capacity to a recipient storage pool. In embodiments in which the donor pool transfer action is taken automatically by the storage system as described above, the system administrator is alerted to the fact that a transfer of donor pool storage capacity has performed by the storage system. As a result of the notification, the system administrator may take appropriate action as described below. In embodiments in which the donor pool storage capacity transfer was performed manually by a storage administrator, the notification (block 510, FIG. 11) of donor pool transfer action may provide a reminder to a storage administrator to take any appropriate action as a follow-up to the transfer.

In one embodiment, the donor storage capacity may be added (block 508, FIG. 5) on a temporary basis to not only prevent an imminent out-of-space condition but also to provide an opportunity for the system administrator to address on a more permanent basis, the storage needs of the recipient storage pools to reduce or eliminate any further occurrence of imminent out-of-space conditions. Accordingly, in one embodiment, in response to the notification of donor pool action being taken, additional non-temporary storage may optionally be added (block 511, FIG. 5) to the recipient storage pools to address in a more permanent fashion, the potential out-of-space condition which triggered the transfer of donor storage capacity.

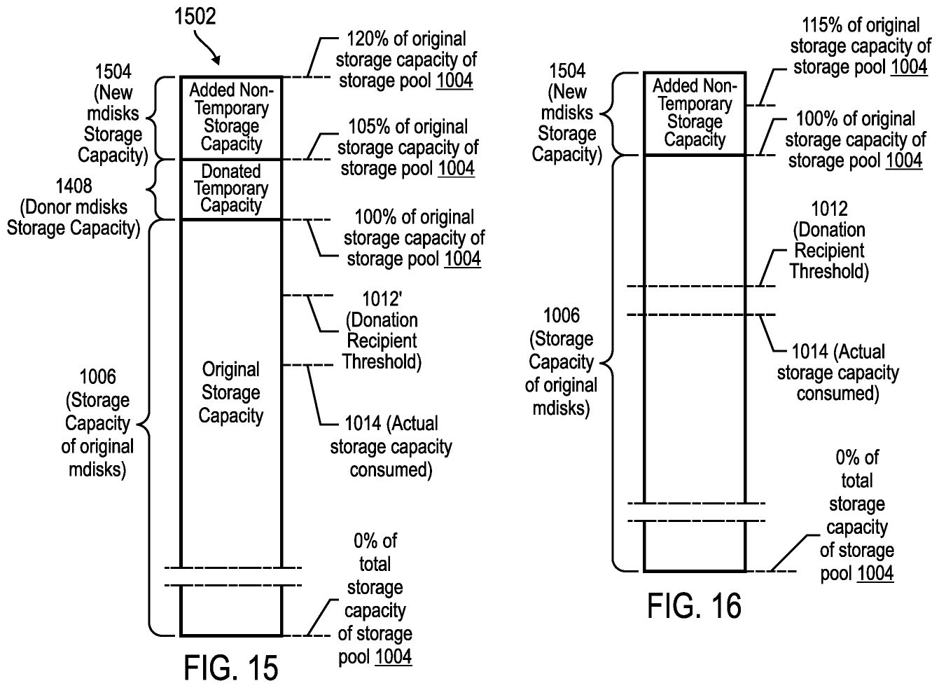

FIG. 15 depicts in graphical form 1502, storage capacity provided by new mdisks which may be, for example, external to the storage system or may be an internal RAID array based mdisks, for example. In this example, the storage capacity of the added non-temporary storage capacity indicated at 1504 is 15% of the original storage capacity of the storage pool 1004. As a result, the total storage capacity of the storage pool 1004 in the example of FIG. 15 is 120% of the original storage capacity, which includes the temporary storage capacity 1408 (5% of original) provided by the donor mdisks, the more permanent storage capacity 1504 (15% of original) provided by the new mdisks, and the original storage capacity 1006 (100% of original) provided by the original mdisks of the storage pool 1004 before any storage capacity was added in the action phase and the notification phase. It is appreciated that the amounts of donor storage capacity and new storage capacity added may vary, depending upon the particular application.

In one embodiment, actual new storage may be added manually by a storage administrator using an appropriate user interface provided by the storage system such as, for example, a user interface provided by the donor pool activity notification logic 816 (FIG. 8). In another embodiment, the new storage may be added automatically by the donor pool activity notification logic 816 (FIG. 8) to resolve space concerns in the recipient pools following notification to the user that the storage system has entered into a condition where space from one pool is temporarily in use by another pool on an emergency basis.

As previously mentioned, storage capacity may be added to a recipient storage pool from one or more donor pools on a temporary, emergency basis in the action phase to avoid an imminent out-of-space condition. Moreover, if new actual storage is added (block 511, FIG. 11) in the notification phase, the addition of such new storage on a non-temporary basis, can further de-escalate the out-of-space emergency. For example, in the reversion phase of FIG. 5, a determination is made (block 512, FIG. 5) as to whether the donor storage capacity donated by one or more donor pools is still needed by the recipient storage pool.

FIG. 15 depicts an example in which, as a result of the addition of new non-temporary storage capacity 1504 provided by the new mdisks, the donation recipient threshold 1012′ of 95% of total capacity is at a higher value in terms of units of storage capacity as compared to its unit value indicated at 1012 in FIG. 10 since the total storage capacity has been increased by the addition of the non-temporary storage capacity 1504. Accordingly, the donation recipient threshold at 1012′ after new storage capacity has been added is no longer being exceeded by the consumed capacity indicated at 1014 in the recipient pool 1004. As a consequence, the out-of-space emergency has been eliminated for the time being and, the donated temporary storage capacity provided by the donor mdisks may be reverted, that is, returned (block 514, FIG. 5) to the source donor pool or donor pools. FIG. 12C depicts such a reversion or restoration in the storage capacity of the donor pool 610 in graphical form 1202c. As shown therein, the storage capacity of the donor pool 610 has been increased back to its original capacity as indicated at 704 in FIG. 12C. More specifically, the storage capacity of the donor pool 610 has been increased by the transfer of the storage capacity of the mdisk 606₁ (FIG. 13) back to the donor pool 610. In addition, the donor volume 1206 (represented in phantom in FIG. 12B) which was mapped to the mdisk 606₁ (FIG. 13) may be deleted.

Before the donated volume is deleted and the donor storage capacity is returned, any data such as extents of data stored in the donated storage capacity, may be migrated from the donated mdisk to the new mdisks that have been added to the recipient pool. Once all the data that had been stored in the donated mdisks is successfully migrated to the new mdisks or other permanent storage within the storage pool 1004, the donated mdisks may be removed (block 514, FIG. 5) from the storage pool 1004 and transferred back to the source donor pools to be available for donation to yet another storage pool facing an imminent out-of-space condition. In this manner, the storage capacity of the recipient storage pool is reduced to 115% of the original storage capacity by the elimination of the donated temporary storage capacity from the recipient storage pool 1004 as shown in the example of FIG. 16.

In one embodiment, the donor pool storage capacity reversion back to the source donor pool is performed by donor pool reversion logic 818 (FIG. 8) of the out-of-space condition risk mitigation controller 255. The operations of the donor pool reversion logic 818 in performing the reversion phase of FIG. 5 may be executed by the logic 818 automatically without substantial system administrator participation. For example, any data stored in the donor volume 1206 (FIG. when donated to the recipient storage pool 1004 (FIG. 15) may be automatically migrated to other storage capacity of the storage pool 1004 to free the donated storage capacity and then the donor volume 1206 and the mdisk mapped to the donor volume may be removed automatically from the recipient storage pool since it is was no longer in use by the recipient pool 1004. These operations would automatically restore the donated mdisk back to the donor pool 610 (FIG. 6) for use by another storage pool in another emergency situation.

Alternatively, operations of the donor pool reversion logic 818 may be executed manually by a system administrator. For example, the donor pool reversion logic 818 could prompt the user to direct the migration of the donor volume data to elsewhere in the recipient storage pool 1004 and then prompt the user to return the donated mdisk and delete the donor volume mapped to that mdisk from the recipient pool.

It is seen from the above that out-of-space condition risk mitigation in accordance with one embodiment, provides for temporarily alleviating out-of-space conditions within a storage system without the need to add new usable capacity to the system. Instead, usable storage capacity already existing within the system is temporarily allocated from one storage pool, to another, different storage pool for use by that other storage system at least on a temporary basis. Once the donated storage capacity is no longer needed by the recipient storage pool, that donated storage capacity may be returned to the donor storage pool and made available for use by other storage pools should the need arise.

One or more of the controllers 810, 812, 814, 816 and 818 (FIG. 8) of the out-of-space condition mitigation controller 255 may be implemented as program modes which may comprise routines, programs, objects, components, logic, data structures, and so on that perform particular tasks or implement particular abstract data types. The program components and hardware devices of the storage computing devices 200 of FIG. 2 may be implemented in one or more computer systems, where if they are implemented in multiple computer systems, then the computer systems may communicate over a network.

Program components of one or more of the controllers 810, 812, 814, 816 and 818 (FIG. 8) of the out-of-space condition mitigation controller 255 may be accessed by a processor from memory to execute. Alternatively, some or all of the controllers 810, 812, 814, 816 and 818 (FIG. 8) of the out-of-space condition mitigation controller 255, may be implemented in separate hardware devices, such as Application Specific Integrated Circuit (ASIC) hardware devices.

The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing g. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

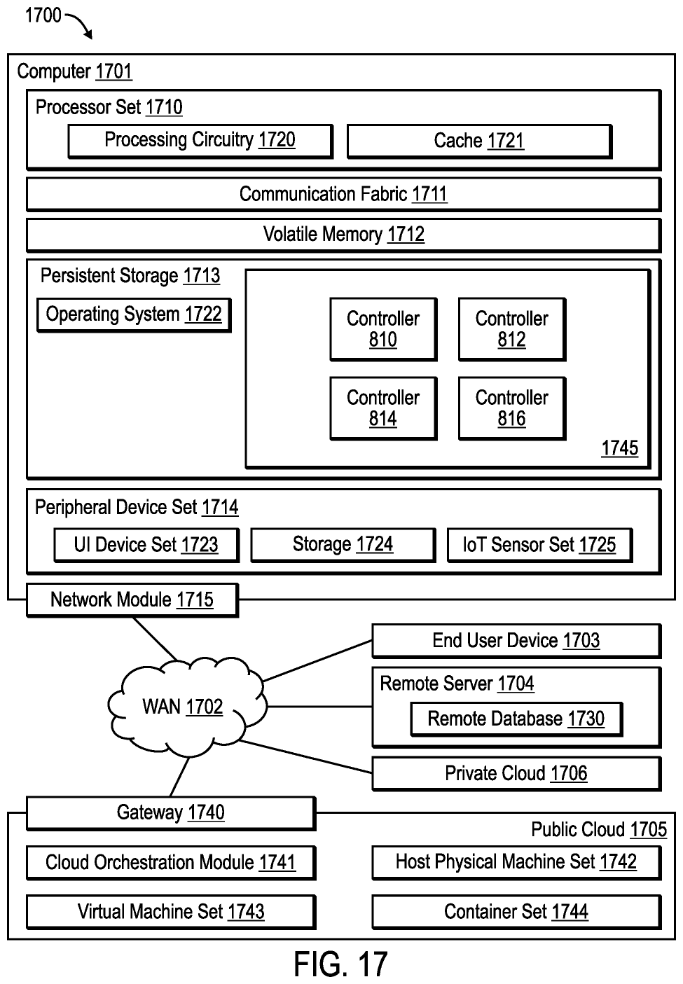

FIG. 17 depicts a computing environment 1700 which contains an example of an environment for the execution of at least some of the computer code involved in performing the inventive methods, including out-of-space condition risk mitigation management using donor storage pools to supplement storage capacity of recipient storage pools. In addition to block 1701, computing environment 1700 includes, for example, computer 1701, wide area network (WAN) 1702, end user device (EUD) 1703, remote server 1704, public cloud 1705, and private cloud 1706. In this embodiment, computer 1701 includes processor set 1710 (including processing circuitry 1720 and cache 1721), communication fabric 1711, volatile memory 1712, persistent storage 1713 (including operating system 1722 and block 1701, as identified above), peripheral device set 1714 (including user interface (UI) device set 1723, storage 1724, and Internet of Things (IoT) sensor set 1725), and network module 1715. Remote server 1704 includes remote database 1730. Public cloud 1705 includes gateway 1740, cloud orchestration module 1741, host physical machine set 1742, virtual machine set 1743, and container set 1744.

COMPUTER 1701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1730. For instance, the computer 1701 may comprise the storage controller 228 (FIG. 2) and the storage 1724 the storage controlled by the storage controller 228. As is well understood in the art of computer technology, and depending upon the technology, performance of a computer-implemented method may be distributed among multiple computers and/or between multiple locations. On the other hand, in this presentation of computing environment 1700, detailed discussion is focused on a single computer, specifically computer 1701, to keep the presentation as simple as possible. Computer 1701 may be located in a cloud, even though it is not shown in a cloud in FIG. 17. On the other hand, computer 1701 is not required to be in a cloud except to any extent as may be affirmatively indicated.

PROCESSOR SET 1710 includes one, or more, computer processors of any type now known or to be developed in the future. Processing circuitry 1720 may be distributed over multiple packages, for example, multiple, coordinated integrated circuit chips. Processing circuitry 1720 may implement multiple processor threads and/or multiple processor cores. Cache 1721 is memory that is located in the processor chip package(s) and is typically used for data or code that should be available for rapid access by the threads or cores running on processor set 1710. Cache memories are typically organized into multiple levels depending upon relative proximity to the processing circuitry. Alternatively, some, or all, of the cache for the processor set may be located “off chip.” In some computing environments, processor set 1710 may be designed for working with qubits and performing quantum computing.

Computer readable program instructions are typically loaded onto computer 1701 to cause a series of operational steps to be performed by processor set 1710 of computer 1701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1721 and the other storage media discussed below. The program instructions, and associated data, are accessed by processor set 1710 to control and direct performance of the inventive methods. In computing environment 1700, at least some of the instructions for performing the inventive methods may be stored in persistent storage 1713.

COMMUNICATION FABRIC 1711 is the signal conduction path that allows the various components of computer 1701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1712 is any type of volatile memory now known or to be developed in the future. Examples include dynamic type random access memory (RAM) or static type RAM. Typically, volatile memory 1712 is characterized by random access, but this is not required unless affirmatively indicated. In computer 1701, the volatile memory 1712 is located in a single package and is internal to computer 1701, but, alternatively or additionally, the volatile memory may be distributed over multiple packages and/or located externally with respect to computer 1701.

PERSISTENT STORAGE 1713 is any form of non-volatile storage for computers that is now known or to be developed in the future. The non-volatility of this storage means that the stored data is maintained regardless of whether power is being supplied to computer 1701 and/or directly to persistent storage 1713. Persistent storage 1713 may be a read only memory (ROM), but typically at least a portion of the persistent storage allows writing of data, deletion of data and re-writing of data. Some familiar forms of persistent storage include magnetic disks and solid-state storage devices. Operating system 1722 may take several forms, such as various known proprietary operating systems or open-source Portable Operating System Interface-type operating systems that employ a kernel. The out-of-space condition risk mitigation management components 1745 typically includes at least some of the computer code involved in performing the inventive methods, including program components of the controller components 810, 812, 814, 816 and 818 (FIG. 8) of the out-of-space condition risk mitigation controller 255 (FIGS. 2, 8).

PERIPHERAL DEVICE SET 1714 includes the set of peripheral devices of computer 1701. Data communication connections between the peripheral devices and the other components of computer 1701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1723 may include components such as a display screen, speaker, microphone, wearable devices (such as goggles and smart watches), keyboard, mouse, printer, touchpad, game controllers, and haptic devices. Storage 1724 is external storage, such as an external hard drive, or insertable storage, such as an SD card. Storage 1724 may be persistent and/or volatile. In some embodiments, storage 1724 may take the form of a quantum computing storage device for storing data in the form of qubits. In embodiments where computer 1701 is required to have a large amount of storage (for example, where computer 1701 locally stores and manages a large database) then this storage may be provided by peripheral storage devices designed for storing very large amounts of data, such as a storage area network (SAN) that is shared by multiple, geographically distributed computers. IoT sensor set 1725 is made up of sensors that can be used in Internet of Things applications. For example, one sensor may be a thermometer and another sensor may be a motion detector.

NETWORK MODULE 1715 is the collection of computer software, hardware, and firmware that allows computer 1701 to communicate with other computers through WAN 1702. Network module 1715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1715 are performed on the same physical hardware device. In other embodiments (for example, embodiments that utilize software-defined networking (SDN)), the control functions and the forwarding functions of network module 1715 are performed on physically separate devices, such that the control functions manage several different network hardware devices. Computer readable program instructions for performing the inventive methods can typically be downloaded to computer 1701 from an external computer or external storage device through a network adapter card or network interface included in network module 1715.

WAN 1702 is any wide area network (for example, the internet) capable of communicating computer data over non-local distances by any technology for communicating computer data, now known or to be developed in the future. In some embodiments, the WAN 1702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1703 is any computer system that is used and controlled by an end user (for example, a customer of an enterprise that operates computer 1701) and may take any of the forms discussed above in connection with computer 1701. EUD 1703, which may include the components of a host 210, 220, 225 (FIG. 2) or a client data processing systems 104A, 104B . . . 104N (FIG. 1B), or a storage controller 204 (FIG. 2), typically sends and receives helpful and useful data which would typically be communicated through network module 1715 of computer 1701 through WAN 1702 to EUD 1703. In this way, EUD 1703 can display, or otherwise present, useful data to be stored or read. In some embodiments, EUD 1703 may be a client device, such as thin client, heavy client, mainframe computer, desktop computer and so on.

REMOTE SERVER 1704 is any computer system that serves at least some data and/or functionality to computer 1701. Remote server 1704 may be controlled and used by the same entity that operates computer 1701. Remote server 1704 may provide for the execution of at least some of the computer code involved in performing the inventive methods, including out-of-space condition risk mitigation management using donor storage pools to supplement storage capacity of recipient storage pools.

PUBLIC CLOUD 1705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1705 is performed by the computer hardware and/or software of cloud orchestration module 1741. The computing resources provided by public cloud 1705 are typically implemented by virtual computing environments that run on various computers making up the computers of host physical machine set 1742, which is the universe of physical computers in and/or available to public cloud 1705. The virtual computing environments (VCEs) typically take the form of virtual machines from virtual machine set 1743 and/or containers from container set 1744. It is understood that these VCEs may be stored as images and may be transferred among and between the various physical machine hosts, either as images or after instantiation of the VCE. Cloud orchestration module 1741 manages the transfer and storage of images, deploys new instantiations of VCEs and manages active instantiations of VCE deployments. Gateway 1740 is the collection of computer software, hardware, and firmware that allows public cloud 1705 to communicate through WAN 1702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1706 is similar to public cloud 1705, except that the computing resources are only available for use by a single enterprise. While private cloud 1706 is depicted as being in communication with WAN 1702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1705 and private cloud 1706 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer program product for processing requests to a storage system, wherein the computer program product comprises a computer readable storage medium having program instructions embodied therewith, the program instructions executable by a processor to cause operations, the operations comprising:
providing a first storage pool which includes a donor storage pool having donor storage capacity;
monitoring capacity usage of a second storage pool having a total usable storage capacity;
detecting a potential out-of-space condition in the second storage pool as a function of the capacity usage monitoring of the second storage pool; and
donating donor storage capacity from the donor pool of the first storage pool to the second storage pool in response to detection of a potential out-of-space condition in the second storage pool, so that donated storage capacity is transferred to the second storage pool.

2. The computer program product of claim 1 wherein the donor storage capacity of the donor pool is virtual donor storage capacity.

3. The computer program product of claim 1, wherein the donating donor storage capacity from the donor pool of the first storage pool to the second storage pool occurs automatically in response to detection of a potential out-of-space condition in the second storage pool, so that donated storage capacity is transferred automatically to the second storage pool.

4. The computer program product of claim 1 wherein the operations further comprise:
notifying a storage administrator that donor storage capacity of the donor pool has been transferred to the second storage pool; and
adding supplemental storage having a supplemental storage capacity to the second storage pool.

5. The computer program product of claim 4 wherein the operations further comprise:
in response to the adding the supplemental storage capacity to the second storage pool, migrating data stored in the storage capacity donated to the second storage pool; and
reverting the donated storage capacity of the donor pool back to the donor pool of the first storage pool so that the reverted donor capacity is available for donation to another storage pool.

6. The computer program product of claim 1 wherein the operations further comprise:
in response to the detecting a potential out of space condition in the second storage pool, prompting a storage administrator to select a donor pool for donating storage capacity to the second storage pool; and
throttling data write operations to the second storage pool until a donor pool selection is received and donor storage capacity is transferred from the selected donor pool to the second storage pool.

7. The computer program product of claim 1 wherein the donor pool of the first storage pool and the second storage pool are each assigned to a tier of hierarchical storage in which each tier has a different storage data transfer rate as compared to that of another tier, and wherein the operations further comprise selecting the donor pool from a tier which has a storage data transfer rate which is one of 1) the same as the storage data transfer rate of the tier of second storage pool, and 2) lower than the storage data transfer rate of the tier of second storage pool.

8. The computer program product of claim 1 wherein the operations further comprise:
providing a third storage pool which includes a donor storage pool having donor storage capacity;
monitoring capacity usage of the third storage pool with respect to first and second thresholds of capacity usage wherein the second threshold is higher than the first threshold;
detecting a potential out-of-space condition in the third storage pool as a function of the capacity usage monitoring of the third storage pool with respect to the first threshold;
converting donor storage capacity from the donor pool of the third storage pool to non-donor storage capacity in response to detection of a potential out-of-space condition in the third storage pool as a function of the capacity usage monitoring of the third storage pool with respect to the first threshold; and
donating donor storage capacity from the donor pool of the first storage pool to the third storage pool in response to detection of a potential out-of-space condition in the third storage pool as a function of the capacity usage monitoring of the third storage pool with respect to the second threshold, so that donated storage capacity is transferred to the third storage pool.

9. A computer-implemented method, comprising:
providing a first storage pool which includes a donor storage pool having donor storage capacity;
monitoring capacity usage of a second storage pool having a total usable storage capacity;
detecting a potential out-of-space condition in the second storage pool as a function of the capacity usage monitoring of the second storage pool; and
donating donor storage capacity from the donor pool of the first storage pool to the second storage pool in response to detection of a potential out-of-space condition in the second storage pool, so that donated storage capacity is transferred to the second storage pool.

10. The method of claim 9 wherein the donor storage capacity of the donor pool is virtual donor storage capacity.

11. The method of claim 9, wherein the donating donor storage capacity from the donor pool of the first storage pool to the second storage pool occurs automatically in response to detection of a potential out-of-space condition in the second storage pool, so that donated storage capacity is transferred automatically to the second storage pool, the method further comprising:
notifying a storage administrator that donor storage capacity of the donor pool has been transferred to the second storage pool;
adding supplemental storage having a supplemental storage capacity to the second storage pool;
in response to the adding the supplemental storage capacity to the second storage pool, migrating data stored in the storage capacity donated to the second storage pool; and
reverting the donated storage capacity of the donor pool back to the donor pool of the first storage pool so that the reverted donor capacity is available for donation to another storage pool.

12. The method of claim 9, further comprising:
in response to the detecting a potential out of space condition in the second storage pool, prompting a storage administrator to select a donor pool for donating storage capacity to the second storage pool; and
throttling data write operations to the second storage pool until a donor pool selection is received and donor storage capacity is transferred from the selected donor pool to the second storage pool.

13. The method of claim 9 wherein the donor pool of the first storage pool and the second storage pool are each assigned to a tier of hierarchical storage in which each tier has a different storage data transfer rate as compared to that of another tier, the method further comprising selecting the donor pool from a tier which has a storage data transfer rate which is one of 1) the same as the storage data transfer rate of the tier of second storage pool, and 2) lower than the storage data transfer rate of the tier of second storage pool.

14. The method of claim 9, further comprising:
providing a third storage pool which includes a donor storage pool having donor storage capacity;
monitoring capacity usage of the third storage pool with respect to first and second thresholds of capacity usage wherein the second threshold is higher than the first threshold;
detecting a potential out-of-space condition in the third storage pool as a function of the capacity usage monitoring of the third storage pool with respect to the first threshold;
converting donor storage capacity from the donor pool of the third storage pool to non-donor storage capacity in response to detection of a potential out-of-space condition in the third storage pool as a function of the capacity usage monitoring of the third storage pool with respect to the first threshold; and
donating donor storage capacity from the donor pool of the first storage pool to the third storage pool in response to detection of a potential out-of-space condition in the third storage pool as a function of the capacity usage monitoring of the third storage pool with respect to the second threshold, so that donated storage capacity is transferred to the third storage pool.

15. A computer system, comprising:
a storage system having a plurality of storage pools;
a host coupled to the storage system;
a processor of at least one component of the computer system; and
a computer program product for managing storage capacity of the storage system, wherein the computer program product comprises a computer readable storage medium having program instructions embodied therewith, the program instructions executable by a processor to cause operations, the operations comprising:
providing a first storage pool which includes a donor storage pool having donor storage capacity;
monitoring capacity usage of a second storage pool having a total usable storage capacity;
detecting a potential out-of-space condition in the second storage pool as a function of the capacity usage monitoring of the second storage pool; and
donating donor storage capacity from the donor pool of the first storage pool to the second storage pool in response to detection of a potential out-of-space condition in the second storage pool, so that donated storage capacity is transferred to the second storage pool.

16. The computer system of claim 15 wherein the donor storage capacity of the donor pool is virtual donor storage capacity.

17. The computer system of claim 15, wherein the donating donor storage capacity from the donor pool of the first storage pool to the second storage pool occurs automatically in response to detection of a potential out-of-space condition in the second storage pool, so that donated storage capacity is transferred automatically to the second storage pool, the operations further comprising:
notifying a storage administrator that donor storage capacity of the donor pool has been transferred to the second storage pool;
adding supplemental storage having a supplemental storage capacity to the second storage pool;
in response to the adding the supplemental storage capacity to the second storage pool, migrating data stored in the storage capacity donated to the second storage pool; and
reverting the donated storage capacity of the donor pool back to the donor pool of the first storage pool so that the reverted donor capacity is available for donation to another storage pool.

18. The computer system of claim 15, wherein the operations further comprise:
in response to the detecting a potential out of space condition in the second storage pool, prompting a storage administrator to select a donor pool for donating storage capacity to the second storage pool; and
throttling data write operations to the second storage pool until a donor pool selection is received and donor storage capacity is transferred from the selected donor pool to the second storage pool.

19. The computer system of claim 15 wherein the donor pool of the first storage pool and the second storage pool are each assigned to a tier of hierarchical storage in which each tier has a different storage data transfer rate as compared to that of another tier, the operations further comprising selecting the donor pool from a tier which has a storage data transfer rate which is one of 1) the same as the storage data transfer rate of the tier of second storage pool, and 2) lower than the storage data transfer rate of the tier of second storage pool.

20. The computer system of claim 15, wherein the operations further comprise:
providing a third storage pool which includes a donor storage pool having donor storage capacity;
monitoring capacity usage of the third storage pool with respect to first and second thresholds of capacity usage wherein the second threshold is higher than the first threshold;
detecting a potential out-of-space condition in the third storage pool as a function of the capacity usage monitoring of the third storage pool with respect to the first threshold;
converting donor storage capacity from the donor pool of the third storage pool to non-donor storage capacity in response to detection of a potential out-of-space condition in the third storage pool as a function of the capacity usage monitoring of the third storage pool with respect to the first threshold; and
donating donor storage capacity from the donor pool of the first storage pool to the third storage pool in response to detection of a potential out-of-space condition in the third storage pool as a function of the capacity usage monitoring of the third storage pool with respect to the second threshold, so that donated storage capacity is transferred to the third storage pool.
